(19) United States
(12) Patent Application Publication
(10) Pub. No.: US 2010/0253104 A1
(43) Pub. Date: Oct. 7, 2010

(54) Animal waste collection device and related method

(76) Inventor: Kevin Kirwin, Milford, OH (US)

Correspondence Address: R. CHRISTIAN MACKE, 40 EAST 10TH STREET, NEWPORT, KY, 41071, US

(21) Appl. No.: 12/384,618

(22) Filed: Apr. 7, 2009

(51) Int. Cl. A01K 29/00

(52) U.S. Cl. 294/1.3; 119/161

(57) ABSTRACT

An animal waste collection device. A rectangular receptacle cooperates with a mechanical scooper device used to pick up animal waste. A user holds the mechanical scooper in one hand and the receptacle in the other hand. The receptacle is sufficiently large that the scooper will fit into the receptacle and can be manipulated therein to shake loose the waste in the scooper to transfer it to the receptacle. The receptacle includes a porous bottom and flared upstanding sides. A handle is provided in at least one upstanding side. A disposable liner is provided for use with the receptacle wherein a pocket formed in the liner cooperates with the handle in the receptacle to shield the hand of a user from contact with the receptacle.

### FIELD OF THE INVENTION

This invention relates to an animal waste collection receptacle used in conjunction with a scooper device and a related method for use. More specifically, it relates to a receptacle having a liner and cooperating provisions between the liner and the receptacle.

### BACKGROUND OF THE INVENTION

Millions of dog owners face a problem everyday of cleaning up after their dogs. Most municipalities, parks and other places where dogs are common visitors have specific rules and regulations regarding the necessity of cleaning up after a dog. Particularly in urban settings, it is expected and often a legal requirement that a dog owner cleans up the feces that a dog leaves behind.

The requirement of eliminating dog feces from public areas has become more pronounced as the population, particularly in the United States, has become more conscious of hygiene and health and safety risks posed by poor hygiene. A vast array of sanitary methods and devices for picking up after a dog have predictably been proposed and developed to address the problem. Even for individuals and families that keep dogs within a fenced yard, many still clean up after their dog in their own yard without a legal requirement to do so. Keeping a yard safe and sanitary for entertaining and kids' play, even without legal requirements to do so, generally provides enough motivation and pressure for dog owners to clean up after their dogs.

Thus, various types of scoops and retention receptacles have been proposed in the past for dog owners to use in picking up and disposing of such waste. It is a crowded field of art which has seen the development and patenting of a large number of mechanical scoopers used to pick up the dog waste. Typically with such devices, a scoop mechanism is mounted on the end of an extended handle to allow a user to pick up the waste without having to bend over. Many have mechanical gripping provisions or jaws that can be remotely operated from the distal end of the handle. Some examples of prior art devices are as follows:

U.S. Pat. No. 6,196,600 Miller describes an animal waste scooping and disposal device comprising a plastic telescoping inner pole attached to an aluminum tray having extended forks in front and a triangular shaped waste exiting opening in the rear. The rear end of the tray can be modified with a peripheral groove for attaching a bag. The outer pole has a handle at the upper end, a tray release button and a two-prong female clip-on device to hang a portable rake. Two holding arms from the outer tube support the tray and allow the tray to automatically pivot when waste is added. The device is distinguished by a required pivoting tray with extended fork elements.

U.S. Pat. No. 5,820,179 to Tsou describes a refuse collection device comprising three concentric telescoping tubes. The handle consists of a first grip fixed to the outer tube and a second grip fixed to the intermediate tube. This structural arrangement allows the first grip and the outer tube to be movable relative to the second grip and the intermediate tube. A semicircular shaped (in cross-section) bag mount supporting a refuse collection bag is mounted at the opposite end of the tubes. The semicircular shaped cover is coupled to the outer tube for opening and closing the cover. Spherical members are received within openings in the intermediate tube and spring-biased to engage a recess formed on the outer tube to secure the open cover position. The inner tube is also spring-biased to expand to hold the collection bag. A releasing mechanism moves the inner tube relative to the intermediate tube to release the bag against the biasing spring and to release the outer tube from the open position. The device is distinguished by a multiple tubular shaft structure.

U.S. Pat. No. 6,113,166 Wynn describes a sanitary pickup apparatus for animal feces comprising an open frame assembly vertically supporting a telescoping handle. When the handle is pushed down, a panel sweep assembly is vertically pivoted about a horizontal axis to propel the feces into the open end of a removable receptacle. The apparatus is distinguished by a telescoping handle and open frame structure.

U.S. Pat. No. 5,350,208 to Heinrichson describes an animal waste pickup and disposal unit comprising a pair of opposed jaws having a plastic bag removably disposed within and attached to a scissors mechanism actuated by an actuator element on the handle. The apparatus is distinguished by a clamping jaw structure.

U.S. Pat. No. 5,380,054 to Galvis describes a handheld device for picking up objects comprising a handgrip assembly, an elongated tubular shaft, a combination plunger and double bell-crank assembly, and clamshell buckets or gripping jaws. The device is distinguished by a unique clamshell bucket or gripping jaw element.

U.S. Pat. No. 5,895,082 to Kaluzny describes a manual pick-up device comprising a pair of pick-up blades attached to a bent shaft having a handle grip. The device is distinguished by a pick-up bladed structure.

U.S. Pat. No. 6,030,011 to Layton describes a waste collection device comprising an elongated handle having a rake device clipped to it for sweeping waste into a waste receptacle frame at the end of the handle for attaching a liner over the waste receptacle frame. The device is distinguished by a required rake and waste receptacle frame.

U.S. Pat. No. 6,062,168 to Host et al. describes a sanitary refuse and animal dung collection valet device comprising a pair of tubes pivotally connected in a scissors arrangement. The user scoops the waste into a refuse collection bag which is supported at the lower end of one tube on a support frame. A pusher paddle connected to the lower end of the other tube scrapes the waste into the bag. The device is distinguished by its scissors arrangement and requiring a pusher paddle.

U.S. Pat. No. 6,068,311 to Jones describes a sanitary pickup device comprising a pair of wire bails on one end of a tubular shaft and a handle shaped either as a bend or a pistol grip. A stationary wire bail and a movable wire bail are fixed to a yoke member. The device picks up the animal dropping by the wire bails to drop into an open bag. The device is distinguishable for its open bail structure.

U.S. Design Pat. No. 369,444 to Ubdegrove et al. describes an animal feces retriever device comprising a clamping tray with two jaws with one lower jaw fixed to the end of a cylindrical rod and the upper jaw raised by a cable to the pistol grip handle. The device is distinguished by clamping jaws.

U.S. Pat. No. 4,986,587 to Lozano describes an animal waste collecting device comprising a two-piece post having a perpendicular handle at the top and a rod frame supporting a scoop with a normally extending edge portion with a curved upper edge. A paper or polyethylene bag is attached to the ends of the rod frame and to an L-shaped hook on the lower post. The device is distinguished by a flat tray structure with the three-point attachment for the bag.

U.S. Pat. No. 4,958,871 to Hemans describes a hand tool for picking up animal droppings comprising a telescopic handle with a belt clip and a spring loaded locking and release button attached to a scooping device. The scooping element comprises a pair of support arms and a centered hook with a tapered blade to form a substantially rectangular opening for a fold-lock-up sandwich bag. The hand tool is distinguished by a limited height requiring bending over and the use of special sandwich bags.

U.S. Pat. No. 4,962,956 to Scripter describes an animal waste collection device comprising a straight tubular handle having a retention slot for holding a plastic bag retained on a triangular spring wire frame. The device is pulled towards the user. The device is distinguished by a triangular wire frame structure and the lack of a closure element.

In addition to these prior designs for the scooping device, a large amount of prior art has been directed to the retention receptacle for holding the waste. Some specific examples of that prior art are as follows:

U.S. Pat. No. 4,047,746 is directed to a simple metal frame for holding a flexible bag open so that the waste can be placed therein. The frame/bag assembly may be held in one hand while the waste is picked up with the hand or, possibly, by any of the prior art scooper devices.

U.S. Pat. No. 4,252,356 describes a bag with a sealing tab and closure mechanism affixed thereto. A user may hold the bag in one hand while using a prior art scooper mechanism with the other. A clear disadvantage of this assembly is the flimsy nature of the bag and the difficulty that a user will have in keeping it open while the waste is place in it.

U.S. Design Pat. No. D453,067 shows a belt mounted case and bag kit for retaining the dog waste collected. Also, U.S. Pat. No. 6,129,096 describes a clean up kit and method including gloves and bags and other items stored in a shoulder mounted bag.

The discussion of these prior art devices is intended to be illustrative and not comprehensive as a description of the prior art. As is apparent from the prior art, however, one embodiment of a waste collection device may generally be described as a hand operated scooper typically used to pick up the waste and then place it into a separate retention receptacle. However, a significant problem with the prior art retention receptacles is that they have not been sized or designed to allow the separate scooper device to extend fully into the retention receptacle; rather, the scooper mechanism is positioned over the prior art receptacles and the waste dropped therein. However, the handling of a long handle mounted scooper device is often unwieldy and results in a lot of misses when placing the waste into the receptacle. The waste must then be re-scooped and placed into the retention receptacle, and thus requires double the time and effort.

In addition, the prior art retention receptacles suffer from a number of other drawbacks. Bags mounted on frames by draping a top edge over the frame often suffer from the problem of the bags becoming torn or detached from the frame, resulting in spillage of the contents, more work and effort, and the unsanitary effect of having the waste come into contact with the frame or, possibly, the user or his clothes. The bags becoming torn or detached often result from inadequate attachment provisions between the bags and receptacles, inadequate conformance of the bags to the shape of the receptacle, and contact with sharp edges of a scooper device. Inadequate conformance of the bag to the receptacle occurs when installing a bag into a receptacle because an air pocket formed under the bag prevents the bag from fitting tightly against the walls of the receptacle. Air trapped between the liner and receptacle presents the problem frequently encountered with kitchen garbage bags, that an air bubble keeps the bag from being fully opened to conform to the receptacle shape until it is either pushed down by the user's hand or by depositing waste therein to push the bag down and against the walls of the receptacle. In most instances, the air bubble is eventually expelled over the sidewalls of the receptacle as the bag is filled with-waste. In the present use, such a method for the expulsion of air is problematic because the scooper device is repeatedly placed into, operated or shaken, and removed from the receptacle, resulting in frequent tears in the liner. This problem is exacerbated by the construction of scooper devices that have sharp edges or teeth to pick up the animal waste. It would be advantageous to provide an arrangement wherein air between the bag and the receptacle is readily removed or expelled, allowing the bag to conform to the shape of the receptacle to reduce the likelihood of being torn by the scooper device as it is inserted to deposit the waste received therein. This arrangement is further improved by providing a scooper device with soft, rounded edges to reduce the possible causes of tearing the bag.

It would be most advantageous to provide a retention receptacle that is easily held by a user with one hand to allow the other hand to be free to use any of the various prior art scooper devices. The retention receptacle would be large enough for the scooper to be positioned completely within the receptacle and manipulated to separate and transfer the waste from the scooper to the receptacle.

In addition, it would be advantageous to provide cooperating provisions to allow secure attachment of the bag to the receptacle that promotes conformance of the bag to the shape of the receptacle. This is done to facilitate insertion and removal of the scooper device therefrom, and to reduce causes of tearing and detaching the bag. The scooper device is also provided with tear reduction provisions providing soft and rounded features.

As with kitchen garbage bags, it would also be advantageous to have provisions on the receptacle for receiving and holding secure the bag liner thereon. In addition, recognizing the desire to keep the procedure as sanitary as possible, it is desirable to include provisions for handling the bag and receptacle that keeps the user's hands shielded from any contact with the frame or waste.

### OBJECTS OF THE INVENTION

It is an object of this invention to provide a device of the character described comprising a receptacle and liner combination to receive the waste from a scooper by allowing the scooper to be completely positioned within and manipulated within the receptacle to transfer the waste from the scooper to the receptacle.

Another object of this invention is to provide a device of the character described in which a liner bag is positioned within the receptacle in such a way that the user holding the receptacle may readily and sanitarily do so with one hand, his hand being shielded from contact with the waste or even the receptacle itself.

Still another object of this invention is to provide a device of the character described having means for a user to hold the assembled receptacle and liner combination with one hand while the other hand is free to use a scooper device.

Another object of the present invention is to provide a receptacle that receives a liner in such a manner that air between the liner and the receptacle is expelled to promote conformance of the liner to the receptacle.

Yet another object of the present invention is to provide a lined receptacle for use with a scooper device that reduces the likelihood of tearing the liner with the scooper device.

Yet another object of this invention is to provide a receptacle of the character described which shall be relatively inexpensive to manufacture, easy to manipulate, sanitary in use and which shall yet be practical and efficient to a high degree.

It is an object of the present invention to provide an animal waste collection receptacle having means for retaining and securing a liner thereon.

It is another object of the present invention to provide a liner for use within a receptacle having cooperating provisions between the liner and receptacle to provide a sanitary barrier between the user and the waste and receptacle.

It is yet a further object of the present invention to provide an animal waste collection device comprising a retention receptacle large enough to receive a scooper device, the receptacle further having provisions for receiving a liner and conforming the liner to the shape of the retention receptacle.

It is a further object of the present invention to provide an animal waste collection device comprising a scooper device having soft and rounded edges to reduce the likelihood of tearing the liner in the receptacle.

It is yet another object of the present invention to provide a receptacle for holding a liner wherein the receptacle is readily and thoroughly cleaned after removal of the liner as a result of the receptacle being formed with a porous bottom.

It is another object of the present invention to provide a method for disposing of animal waste with a scooper and receptacle that allows the user to do so without having to touch the waste or receptacle.

These and other objects and advantages of the present invention will be apparent from a review of the following specification and accompanying drawings.

### SUMMARY OF THE INVENTION

The present invention provides an animal waste collection receptacle comprising most basically a rigid receptacle. A removable flexible liner is provided that is secured to the receptacle. An opening in the receptacle is large enough for a scooper device, operated by one hand of a user, to be inserted and manipulated therein to transfer animal waste from the scooper into the receptacle/liner.

In its most preferred embodiment, the animal waste collection receptacle is essentially rectangular and comprises flared upright panels and a wide mouth accommodating the scooper. The animal waste collection receptacle also comprises a porous bottom panel.

The animal waste collection receptacle of the present invention has a handle means formed in at least one of said flared upright panels. Specifically, the handle means comprises a slot formed in one of the flared upright panels of the receptacle.

The animal waste collection receptacle of the present invention also comprises means for engaging the handle means and means for securing the liner to the receptacle. The liner further comprises means for protecting a user's hand from contact with the receptacle.

The animal waste collection receptacle of the present invention also provides means for securing the liner to the receptacle comprising downwardly depending hooks.

The principles of the present invention also provide a related method for disposing of animal waste comprising multiple steps. The first step is providing a scooper operated by one hand. Next, a receptacle is provided that is sufficiently large to allow insertion and manipulation of the scooper therein, the receptacle having a handle and being easily transported and manipulated with one hand. Next, a liner is positioned in the receptacle, the liner having a protective hand grip pocket. The next step in the method is folding down an upper portion of the liner, followed by engaging the hand grip pocket with the user's hand. The inventive method also comprises the step of lining up the hand grip pocket with the handle.

Finally, the inventive method further comprises the steps of positioning the head of the scooper device completely within the receptacle and then operating the scooper while it is within the receptacle to shake any waste held in the scooper into the receptacle.

### BRIEF DESCRIPTION OF THE DRAWINGS

FIG. 1 is an illustration of a typical user holding a waste scooper in one hand and the receptacle of the present invention in the other hand.

FIG. 2 is a perspective view of the receptacle and liner combination of the present invention.

FIG. 3 is a side view of the receptacle illustrating the presence of a handle formed in one of the upstanding panels.

FIG. 4 is a front view of the receptacle of the present invention illustrating the tapered sides and large mouth of the receptacle accommodating the insertion and manipulation of the scooper therein.

FIG. 5 is a perspective view of the receptacle of the present invention illustrating the presence of a bottom perforated by holes or screening to allow water to pass therethrough for cleanout.

FIG. 6 is a perspective view of the liner of the present invention prior to insertion and combination with the receptacle in which the location of the sanitary pocket is disclosed.

FIG. 7 is a front view of the liner inserted in the receptacle with the top edge of the liner overhanging the top of the receptacle.

FIG. 8 is a front view illustration of the receptacle and liner combination of the present invention in which a user's hand engages the liner and the receptacle handle and is provided a sanitary shield from contact with the waste and the receptacle itself.

FIG. 9 is a front view of the one hand operated scooper device depicting soft rounded edges to minimize tearing of the liner.

FIG. 10 is a detailed schematic depicting operation of the mouth of the scooper device with soft rounded edges.

FIG. 11 is a perspective view of the receptacle and liner of the present invention schematically representing the expulsion of air from between the liner and receptacle.

### DETAILED DESCRIPTION OF THE INVENTION

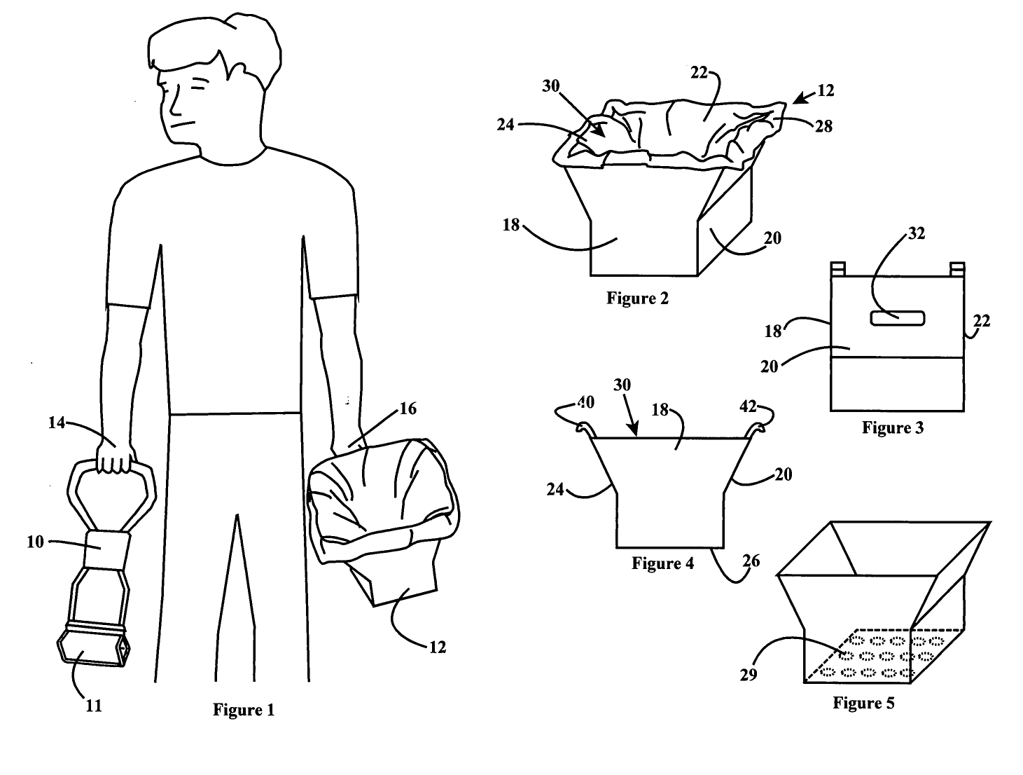

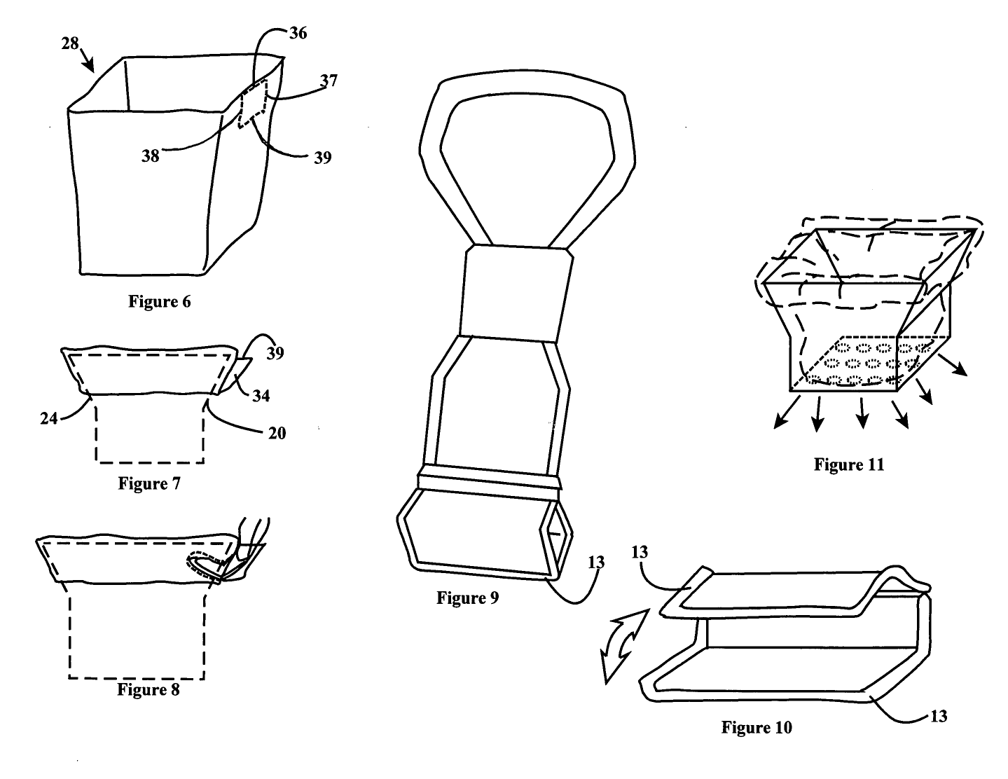

The present invention relates to a device used by a typical dog owner, or other person charged with cleaning up after a dog, such as illustrated in FIG. 1 comprises a scooper device 10 held in one hand 14 while a waste receptacle 12 is held in the other hand 16. In operation the user picks up dog waste with the scooper 10 by operating mechanical gripping provisions embodied within the scooper 10 to pick up and trap dog waste in the jaws 11 of the scooper 10. The scooper 10 is then held over or in the receptacle 12 and the jaws 11 and scooper 10 manipulated to shake the waste free from the scooper 10 and into the receptacle 12. It is to be understood that the scooper 12 is a generally described device allowing one hand operation to pick up dog waste, or other garbage on the ground, without requiring a user to bend over to do so.

In a significantly advantageous feature of the present invention, the receptacle 12 is provided with a large mouth 30 that allows the scooper 10 to be positioned and manipulated within the receptacle 12 to prevent spillage as the waste is being transferred from the scooper to the receptacle 12. These provisions are advantageous over the prior art devices because the receptacle is sufficiently large to allow insertion of the scooper device therein, and because the scooper device 12 is provided with a soft, rounded perimeter 13 on both the top and bottom plates of the jaws 11 (FIG. 10). The soft rounded perimeter 13 allows the user to insert and vigorously shake the scooper device 10 in the receptacle 12 without tearing the liner 28. The soft rounded perimeter 13 comprises a means for reducing tearing the liner 28 by eliminating sharp edges on the scooper device 10.

The receptacle 12 is sized and designed to receive a liner 28, similar to a typical garbage can liner with additional provisions discussed in more detail herein. The liner 28 is intended to be for a single use and disposable.

The receptacle 12 comprises a number of individual elements. Four upstanding walls 18, 20, 22, 24 are connected to each other and to a bottom 26 to form an enclosure having an open mouth 30 at one end opposite the bottom 26. In the most preferred embodiment of the present invention, the bottom 26 is formed with perforations 29 to allow easy cleaning, for water and debris to pass easily through. It is specifically contemplated that the bottom 26 may also be formed from screening or other permeable or porous material, such that the use of such a substitute material does not depart from the principles of the present invention.

Providing a bottom 26 with perforations 29 is further advantageous because air that would otherwise be trapped between the liner 28 and receptacle 12 is expelled through the bottom 26. This allows the liner 28 to conform to the shape of the receptacle 12 and not to be deformed by an air bubble beneath it. Eliminating the trapped air beneath the liner 28 provides further means for reducing tearing of the liner 28.

In the most preferred embodiment of the present invention, the receptacle 12 has two parallel, vertically upstanding walls 18, 22 and two walls 20, 24 that are at least partially flared outwardly as shown in FIG. 4 to make the receptacle 12 larger at the top mouth 30 than at the bottom 26. This shaping and sizing of the receptacle 12 resulting from the inclusion of the tapered walls 20, 24 is critical and provides a functional benefit to the receptacle 12 because the mouth 30, as a result of the tapering of the walls 20, 24, is large enough to not only receive the jaws 11 of the scooper 10, but also provides sufficient room for the jaws 11 to be operated and shaken to free the waste therefrom. For other scooper devices 10 employing a different closure or trapping mechanism other than cooperating jaws 11, the receptacle 12 is sufficiently large to allow repeated operation of the closure or trapping mechanism to shake the waste free from the scooper 10.

The most preferred embodiment of the present invention contemplates that the receptacle 12 will be held in one hand by a user, as depicted in FIG. 1, while a scooper device 10 is held in the other. It is thus desirable that the receptacle 12 has provisions for being held by one hand at handle 32 that not only allow it to be held securely, to prevent spillage, but also to be held in such a way that is sanitary and does not expose the user to contact with the waste being transferred into the receptacle 12 or, in the most preferred embodiment, does not even require contact with the receptacle 12 itself.

While many of the prior art solutions have contemplated the use of sanitary gloves to be worn by a user when cleaning up dog waste to prevent contact of the hands with the waste or the receptacle, the present invention includes provisions for shielding the user's hands without requiring gloves. In its most basic adaptation, the liner 28 is tall enough and provided with enough overhang, when the edges are folded down over the receptacle 12 as shown in FIG. 7, that the user can grip the upstanding wall 20 of the enclosure 12 at the handle 32 (see FIG. 3) by gripping the overhang portion of the liner 28 and pushing it up through the handle 32. The liner 28 used in conjunction with the receptacle 12, depicted in FIG. 5, has a pocket 34 formed on the inside of the liner 28 as shown. The pocket 34 provides a means for the user's hand to securely engage the liner 28 by being sandwiched between two welded pieces of material forming the pocket 34. The pocket 34 in the most preferred embodiment is essentially rectangular with closed seams 36, 37, 38 attaching it to the liner 28. The pocket 34 is open along the bottom perimeter 39 so that, as the liner 28 is inserted into the receptacle 12 and the top of the liner 28 is folded over the upstanding walls 20, 24 of the receptacle 12 (see FIG. 7), the open seam 39 of the pocket 34 is now accessible to the hand of a user from the top. While the pocket 34 is depicted in the most preferred embodiment as being rectangular, it is specifically contemplated that it may be formed differently or from a different shape or as a strap connected on two sides only without departing from the principles of the present invention.

After the liner 28 is inserted into the receptacle 12 as shown in FIG. 7, a user's hand may engage the pocket 34 as shown in FIG. 8. The user slides his hand into the pocket 34 and curls his fingers upwardly (FIG. 8) to engage the handle 32 formed in the upstanding wall 20 (see FIG. 3). The handle 32 provides the means for a user's hand to engage the receptacle 12 such that it may be held rigidly and securely. In the most preferred embodiment of the present invention the handle 32 is an essentially oval shaped void formed in the upstanding wall 20, but other shapes and forms for the handle 32, such as rectangular slots or protruding handles, are specifically contemplated and do not depart from the principles of the present invention.

To avoid breaking or disconnection of the liner 28 from the receptacle 12, upwardly depending hooks 40, 42, 44, 46 are provided at the four corners of the receptacle 12 to maintain the position and attachment of liner 28 relative to the receptacle 12.

The pocket 34 formed in the liner 28 has a number of advantages. It provides a sanitary barrier for the user's hand so that he need not have any contact with the waste or even the receptacle 12. In addition, the pocket 34, by being pushed through the handle 32 and gripped by a user, helps secure the liner 28 to the receptacle 12. The pocket 34, formed in the liner 28, and the handle 32, formed in the wall 20 of the receptacle 12, thus constitute coordinated and cooperating elements comprising means for securing the liner 28 to the receptacle 12, as well as providing a means for shielding the user's hand from unwanted contact with the waste or even with the receptacle 12.

A method for disposing of animal waste is also disclosed as a preferred embodiment of the present invention. The first step in the inventive method is to provide the scooper 10 with jaws 11 that are operated by one hand of a user. The receptacle 12 is provided that is sufficiently large to allow insertion and manipulation of the scooper 10 therein. The receptacle 12 is necessarily provided with a handle 32 that allows the receptacle 12 to be held by one hand.

A liner 28 is also provided in the inventive method, and positioned within the receptacle 12, expelling any air trapped between the liner 28 and receptacle 12 when the liner 28 is so positioned, as depicted in FIG. 11. In a significant feature of the inventive method, the liner 28 is provided with a protective hand grip pocket 34. Next, the upper portion of the liner 28 is folded down to spill over the edges of the receptacle 12, and the user lines up the pocket 34 with the handle 32 and engages the hand grip pocket 34 with his hand, thereby pushing the pocket 34 up through the handle 32 as shown in FIG. 8.

The final steps in the inventive method are the steps of positioning the jaws 11 of the scooper 10 completely within the receptacle 12 and operating and shaking the scooper 10 within the receptacle 12 to shake any waste held in the scooper 10 free from the scooper 10 and into the receptacle 12.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

I claim:

1. An animal waste collection receptacle comprising:
a rigid receptacle;
a removable flexible liner secured to said receptacle;
wherein an opening in said receptacle is large enough for a scooper to be inserted and manipulated therein to transfer animal waste from said scooper into said liner.

2. The animal waste collection receptacle of claim 1 wherein said receptacle is essentially rectangular.

3. The animal waste collection receptacle of claim 2 wherein said receptacle further comprises flared upright panels and a wide mouth accommodating said scooper.

4. The animal waste collection receptacle of claim 3 further comprising a porous bottom panel.

5. The animal waste collection receptacle of claim 3 further comprising a handle means formed in at least one of said flared upright panels.

6. The animal waste collection receptacle of claim 5 wherein said handle means comprises a slot formed in said at least one of said flared upright panels.

7. The animal waste collection receptacle of claim 5 wherein said removable flexible liner comprises means for engaging said handle means and means for securing said liner to said receptacle.

8. The animal waste collection receptacle of claim 7 wherein said liner further comprises means for protecting a user's hand from contact with said receptacle.

9. The animal waste collection receptacle of claim 8 wherein said means for securing further comprises downwardly depending hooks.

10. An animal waste collection device comprising:
a scooper device;
a rigid retention receptacle sufficiently large to receive said scooper device therein;
a removable, flexible liner secured to said receptacle; and
means for preventing said scooper device from tearing said liner.

11. The animal waste collection device set forth in claim 10 wherein said means for preventing comprises soft, rounded edges on said scooper device.

12. The animal waste collection device set forth in claim 11 wherein said means for preventing further comprises means for effecting conformance of said liner to said receptacle.

13. A method for disposing of animal waste comprising the steps of:
providing a scooper having jaws operated by one hand;
providing a receptacle sufficiently large to allow insertion and manipulation of said scooper therein, said receptacle having a handle and being easily transported with one hand;
providing a liner to be positioned in said receptacle, said liner having a protective hand grip pocket;
folding down an upper portion of said liner; and
engaging said hand grip pocket with a user's hand.

14. The method as set forth in claim 10 further comprising the step of lining up said hand grip pocket with said handle.

15. The method as set forth in claim 14 further comprising the steps of:
positioning said jaws of said scooper completely within said receptacle; and
operating said scooper while within said receptacle to shake any waste held in said scooper free from said scooper and into said receptacle.
